(19) United States
(12) Patent Application Publication
(10) Pub. No.: US 2026/0053100 A1
(43) Pub. Date: Feb. 26, 2026

(54) Atrium Hybrid Greenhouse

(71) Applicant: Carlos Bishop, Escondido, CA (US)

(72) Inventor: Carlos Bishop, Escondido, CA (US)

(21) Appl. No.: 19/195,553

(22) Filed: Apr. 30, 2025

Related U.S. Application Data
(63) Continuation-in-part of application No. 17/071,706, filed on Oct. 15, 2020, now abandoned.

(51) Int. Cl. A01G 9/14; A01G 9/24

(52) U.S. Cl. CPC A01G 9/14; A01G 9/241

(57) ABSTRACT

An atrium hybrid greenhouse. The greenhouse employs the skeleton structure of columns, girders, and joists of an industrial metal building on which are spaced external and internal walls, and spaced roof and ceiling. The spaced walls form a wall cavity therebetween, and the roof and ceiling form a ceiling cavity there between. A radius cave channel is used to connect the wall cavity and the ceiling cavity for fluid flow therebetween. The external and internal wall and roof/ceiling panels are formed of relatively stiff light transmissive material such as polycarbonate. The formed cavity also provides insulation value.

### RELATED APPLICATIONS

This application is a continuation-in-part of U.S. patent application Ser. No. 17/071,706 entitled “Atrium Hybrid Greenhouse,” filed on Oct. 15, 2020, and currently co-pending, the entirety of which is incorporated by reference herein.

### FIELD OF THE INVENTION

This invention relates generally to a greenhouse or other exterior transparent structures and more particularly, to apparatus for converting a basic joist and girder industrial metal building to a functional greenhouse for effective use in cold climates, high heat, or high humidity conditions, among others. This invention also relates generally to industrial, commercial and residential structures with non-transparent conventional exterior materials.

### BACKGROUND OF THE INVENTION

There are many greenhouse structures. There are many basic warehouse or industrial building structures. Generally, these two types of structures are not compatible. Industrial metal buildings are not conducive to the high levels of interior illumination that are required for maximum daylight transmission coupled with the heat/cold insulation that may be required for growing plants in climates which may experience high heat as well as significant cold temperatures.

In general, buildings designed to function as greenhouses do not include sufficient structure to prevent overheating of the interior in hot climates, such as deserts, nor are they designed to accommodate winter-like weather. Weather conditions which result in high humidity within a building can cause build-up of condensation, mold, mildew, and other types of fungi.

### SUMMARY OF EMBODIMENTS OF THE INVENTION

It is a purpose of embodiments of this invention to modify a basic industrial metal building, warehouse, or other conventionally built structure of any size to enable it to function as an all-weather, sealed, laboratory environment with day lighting control, greenhouse.

The conventional metal column, girder, and joist industrial building structure is the basis for the greenhouse of this concept. To state it in another way, the starting point for the embodiments disclosed is the structural skeleton of an industrial metal building. Such buildings also may employ girts to provide lateral support to the wall panels.

As an option, for security reasons, the external walls may be solid and opaque, to any desired height from the ground level. Typically, the ground level is a foundation/concrete pad on which the building is constructed and to which it is anchored. From the pad, or above the optional solid wall, is the upper wall which extends to the roof. The upper wall may be made of single or multiple layers, standing seam polycarbonate material, glass, or any known relatively rigid, light transmitting, or non-transparent material.

The roof of a standard metal building is typically, as an example, corrugated metal or fiberglass, supported by beams or a truss structure. In cold climates it would typically have sufficient strength to withstand a normal amount of snow and would have a pitch of sufficient steepness or angle to prevent a large accumulation of snow.

As further modified in accordance with the concept described herein, the roof, similar to the walls, would be made of single or multiple layers, standing seam polycarbonate material or any known relatively rigid light transmitting material. However, both the exterior wall and the roof, in accordance with this concept, are double paned. That is, the exterior wall is formed of two spaced light transmissive panels or sheets and the roof/ceiling is also made of two spaced light transmissive panels or sheets which are mounted to the supporting members of the structure. At the upper corner where the dual wall panels meet the dual roof panels, the wall chamber and the roof/ceiling chamber are in fluid communication. While the external and internal panels are secured to supporting structural columns and girts in spaced relationship to form a cavity or channel between them, the supporting structure is formed to permit fluid flow through the channel, laterally and vertically. The same is true for the similarly formed roof/ceiling cavity or channel, to permit fluid flow through the entire roof structure.

Thus, the wall and the roof enable heated or cooling air to flow through the walls and the roof/ceiling to maintain a controlled temperature and environment within the building. As an option, the wall chamber and the roof chamber may be sealed from each other. In addition to heating or cooling, the air within the walls and the roof can be adjusted for proper humidity so that moisture, and resulting mold, does not form within the wall and roof double paneled spaces. In some instances, the fluid flowing in the wall and ceiling chambers may be a form of gas.

The formed cavity also provides insulation value through the use of a cavity treatment and buffer system.

In some embodiments, the air within the cavity that is formed is treated directly through the use of a cavity treatment and buffer system. The cavity treatment and buffer system is a unique tool that allows the cavity to act as a buffer between the exterior and interior conditions of a building. It does so by treating the air within the cavity of a building, and in other embodiments, it is able to treat the air in the cavity of a building and the occupied space of said building. Additionally, the cavity buffer and treatment system can be used as a multi-treatment system that not only cools the air within a building and its respective cavities, but it can also treat the air to remove a handful of different harmful chemicals such as carbon dioxide and carbon monoxide and be used to regulate the humidity.

In some embodiments the cavity treatment and buffer system has multiple different exhaust fans located throughout the cavity that are strategically placed to circulate the air within the space. The circulation of the air improves the heat transfer coefficient of the roof and ceiling panels that are exposed to the cavity and the hot air is subsequently exhausted out of the space through roof venting, wall venting, or a combination of both. Exhausting the hot air prevents the overall temperature of the space from increasing over time, and preventing the heat from transferring into the occupied space of the building. The resulting overall lower temperature in the cavity creates a buffer between the lower temperature of the occupied space of the building and the higher temperature of the outside air; in effect the buffer acts as a second layer of insulation.

In other embodiments, the cavity buffer and treatment system is configured so that the building HVAC system and the cavity exhaust fans work in sync with each other. The HVAC system is configured in these embodiments to deliver the same amount of air to the cavity that is being exhausted out of the space, to ensure that the cavity has neutral pressure. The treated air delivered by the HVAC unit to the cavity is cooler than the hot air being exhausted, so the temperature of the air in the cavity is further reduced, and the effectiveness of the buffer is increased. However, the cavity buffer and treatment system can be set up to ensure that there is either positive or negative pressure present within the building cavity.

The cavity buffer and treatment system can also reduce the carbon footprint of the building that it is installed in. The lower temperature of the air in the cavity reduces the energy demand for treating the air of the occupied space, resulting in lower operation costs for the HVAC unit and lower energy consumption. In some embodiments, the cavity buffer and treatment system reduces the carbon dioxide levels of the building by having plants installed within the cavity. Any plant that is planted within the cavity has a high affinity for carbon dioxide. As the air from the occupied space is exhausted into the cavity, the plants absorb the carbon dioxide present in the air before it is exhausted to the exterior of the building. In some embodiments, the carbon dioxide levels are reduced through the use of direct air capture methods. The occupied space can have exhaust fans configured to have filters that are able to capture any carbon dioxide in the air.

The cavity buffer and treatment system can also be divided into multiple different zones. It does so through the use of a dividing panel that can either laterally or transversally divide the building into different sections. These sections will be highly dependent on the needs of the occupied space immediately below the zone.

The cavity buffer and treatment system can also be used on a variety of different structures instead of being installed only in buildings. For example, it is envisioned that the cavity buffer and treatment system can be installed on structures that are built for anti-gravity applications on Earth, outer space, on the Moon, or any other planet such as Mars. In another example, the cavity buffer and treatment system can be adapted to work on aircraft, spacecraft, space stations, marine vessels, or any other vehicle that may need the cavity buffer and treatment system. Additionally, the cavity buffer and treatment system is designed to avoid any interference with the function of electromagnetic waves (including but not limited to Wi-Fi, cellular, radio, and infrared waves) that are commonly used for wireless communication.

It is also envisioned that the cavity buffer and treatment system can be used in the shape of electrical raceways to better insulate electric wiring where needed. It is fully envisioned that the cavity and buffer system can accommodate a digital network conduit. Other applications include negative or positive pressure conduits, magnetic field conduits for anti-gravity applications in outer space, or any conduits for communication systems (including data, audio, sensory, and smell).

Another benefit to the cavity buffer and treatment system, is that it can have a number of different decorative features installed. In some embodiments, the wall panels that will line the interior space can be decorative in nature by having different designs painted onto them, or they can be smart LED panels that display different images and/or videos. There are also embodiments of the cavity buffer and treatment system where the panels are fully transparent so that the individuals in the building can see the plants installed in the cavity or they can view a fully functioning aquarium. For both the plants and aquarium, the transparent panels provides a clear view of the objects in the cavity and it provides an additional level of security to prevent people from having access to the cavity.

### BRIEF DESCRIPTION OF THE DRAWING

The objects, advantages, and features of the invention embodiments disclosed herein will be more easily understood from the following detailed description, when read in conjunction with the accompanying drawing, in which:

FIG. 1 is a perspective view of a hybrid atrium greenhouse structure in accordance with an embodiment of the invention;

FIG. 2 is a partial perspective view of a corner of a typical industrial metal building structure;

FIG. 3 is a sectional view of the greenhouse structure of FIG. 1;

FIG. 4 is a phantom perspective view of a segment of the FIG. 1 structure;

FIG. 5 is an enlarged sectional view of the corner transition from the wall to roof channels;

FIG. 6 is an enlarged sectional segment of a wall channel; and

FIG. 7 is an enlarged sectional segment of an alternative embodiment of the wall of FIG. 1 mounted to its pad;

FIG. 8 is a perspective view of a building with the cavity buffer and treatment system installed;

FIG. 9 is a section view of a building with the cavity buffer and treatment system installed;

FIG. 10 is a close-up section view of the cavity buffer and treatment system installed;

FIG. 11 is a section view of a building cavity that has a plant and irrigation system installed;

FIG. 12A through 12E are vignette views of different buildings that can have the cavity buffer and treatment system installed;

FIGS. 13A and 13B are an alternative embodiment of the cavity buffer and treatment system that has multi-zone control;

FIG. 14 is an alternative embodiment of the cavity buffer and treatment system that uses a radiant heating system installed in the floor of a building using the cavity buffer and treatment system;

FIG. 15 is an alternative embodiment of the cavity buffer and treatment system that is installed on a hoop house with a gas cannister; and

FIG. 16 is a schematic overview of a control system for the cavity buffer and treatment system.

### DETAILED DESCRIPTION OF EMBODIMENTS OF THE INVENTION

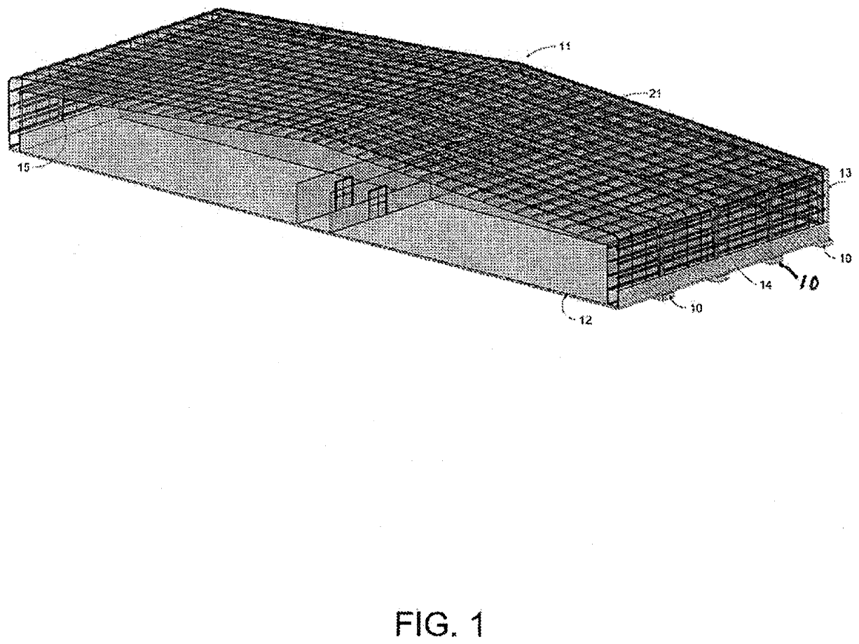

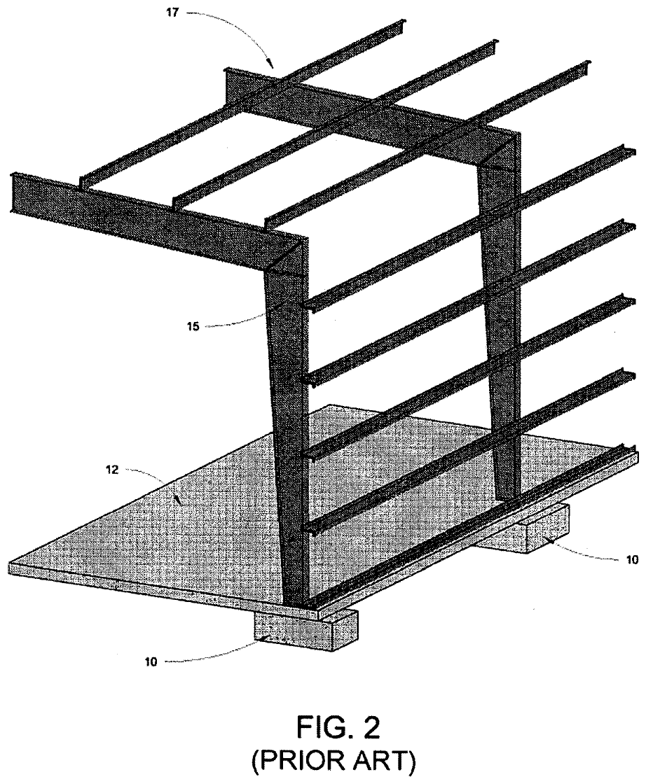

With reference now to the drawing, and more particularly to FIGS. 1 and 2 thereof, a hybrid greenhouse 11 converted from an industrial metal building is shown. The structure typically sits on a concrete foundation or pad 12 and includes walls 13 having external weatherized panels 14 mounted to upright support columns 15. The upright support columns may be secured directly to the pad or to a horizontal plate or beam which is itself secured to the pad. The pad may be further supported on footings 10.

At the top of walls 13 may be horizontal beams or girders to which support columns 15 and the roof structure 17 are mounted. The roof of an industrial metal building is typically comprised of a known truss structure 21, of which there are many forms and of which structure 17 is a part. The outer surface may be corrugated metal or other relatively strong and relatively rigid panels mounted on top of roof structure 21.

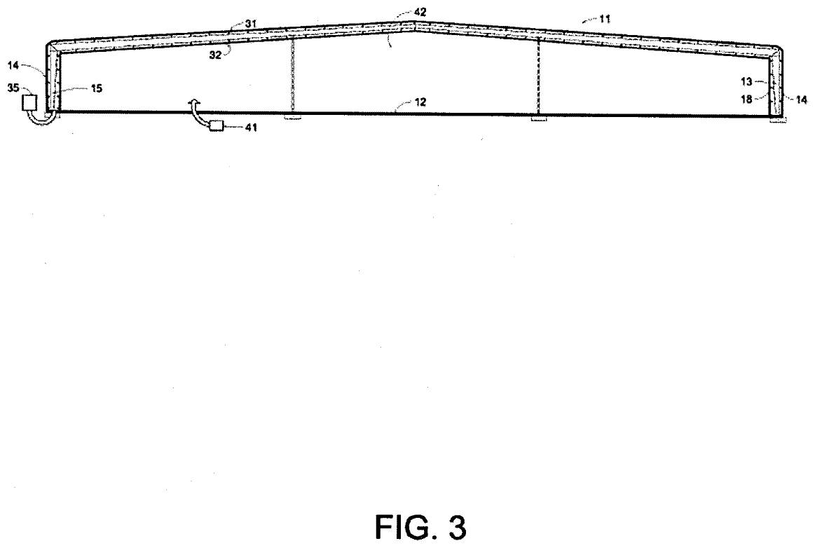

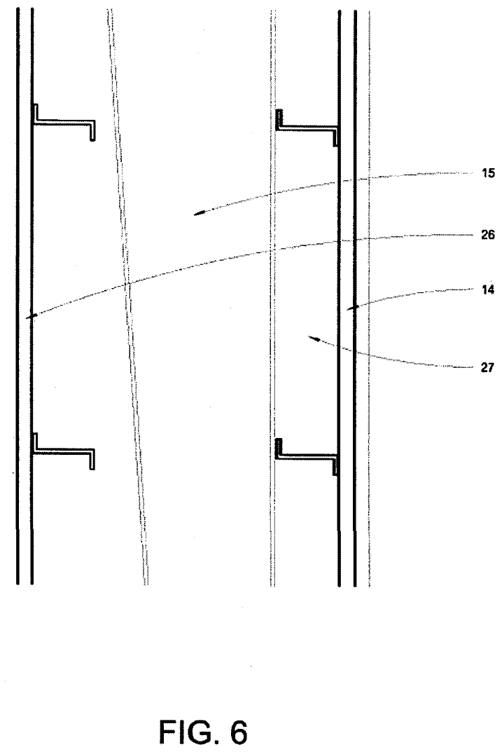

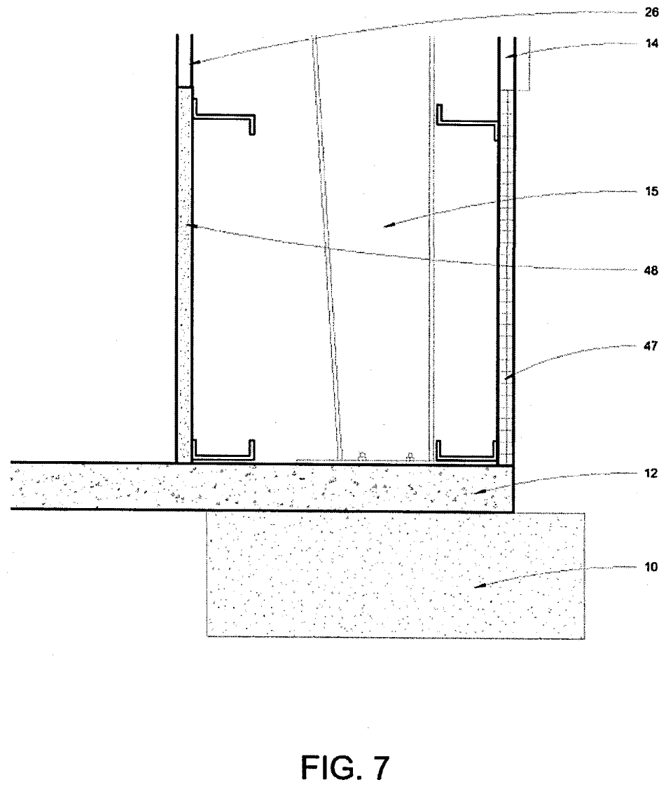

FIGS. 3-7 show how the standard industrial metal building of the type shown in FIG. 2 can be modified, adapted, or converted into an effective, functional hybrid greenhouse. The terms “panel” or “panels” are used herein to refer generally to the planar walls, roof, and ceiling coverings for the column, joist, and girder structural elements. Rather than panels, the walls, roof, and ceiling could be formed of large, continuous sheets that might not be thought of as several panels.

Walls 13 replace the outside walls of the known building with light transmissive weatherized panels 14, which can be made of polycarbonate material or any other material having the proper characteristics to function as an outside wall and also transmit external light (daylight). They should be relatively rigid, that is, they can stand against a wall and remain upright.

Inside walls 18, composed of wall panels 26, are then mounted on the inside of wall support elements 15. Wall panels 14 and 26 are thus spaced, defining chamber or cavity 27 there between. It is contemplated that all four walls (assuming a rectangular building structure) will be constructed to define a continuous similar chamber or cavity. However, they may be separate chambers in fluid communication.

The normally opaque roof panels are replaced by light transmissive outside panels 31, which may also be made of polycarbonate material or other material having the necessary strength and light transmissive properties to function as a roof and to admit appropriate light into the greenhouse.

On the inside of roof structure 17 are mounted inside ceiling panels 32, which may be made of the same material as are roof panels 31. Since ceiling panels 32 do not have to have the same strength requirements as do roof panels 31, they need not be made of the same material or have the same thickness or stiffness.

Panels 31 and 32 are spaced apart and define cavity 33 therebetween. They may be referred to as outside and inside top panels, respectively.

It is preferred that cavities 27 and 33 are sealed to outside air and are in fluid communication in a continuous sealed channel complex. In particular, while each cavity (wall and roof/ceiling) could be generally separate, they are intended to be open internal channels for the same air or gas supply. They could all be in open communication, or each channel or cavity could be separately sealed and be subject to the same air or gas from outside sources. Thus, unit 35 (FIG. 3) could be a heat pump or an air conditioner, or both. Unit 35 could have a single location and supply the desired fluid at the appropriate temperature directly through a coupling in a wall panel 14 or concrete pad 12 or alternatively roof panel 31 to supply the fluid to the entire cavity complex.

Alternatively, there could be several units 35, or one unit 35 could have several conduits coupled separately to cavities 27 and 33.

Another external unit 41 can be employed to supply the desired fluid (air or gas, or both) to the interior 42 of the greenhouse.

The spacing of respective walls panels 14, 26 and roof/ceiling panels 31, 32 is only that necessary to accommodate the building structural elements and to provide sufficient space to enable fluid flow of air or gases in the wall and roof chambers. That spacing could be as little as eight to ten inches and as large as 2.5 feet, and these are only practical spacings and are not limits. In some embodiments, the wall panels 14, 26 and roof/ceiling panels 31, 32 can be positioned at any arbitrary distance from one another. Further, cavities 27 need not have the same width or spacing as cavities 33.

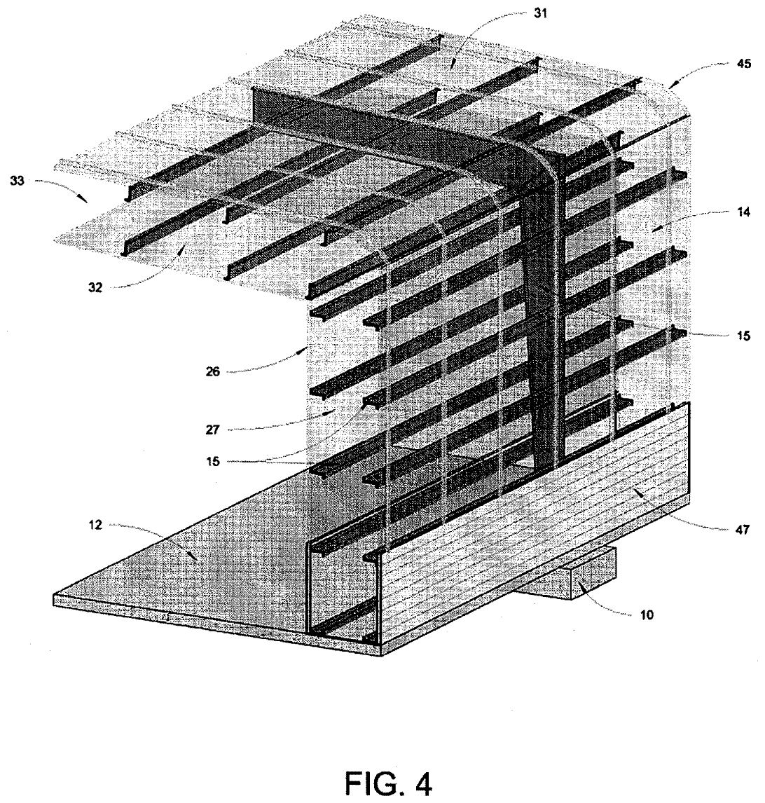

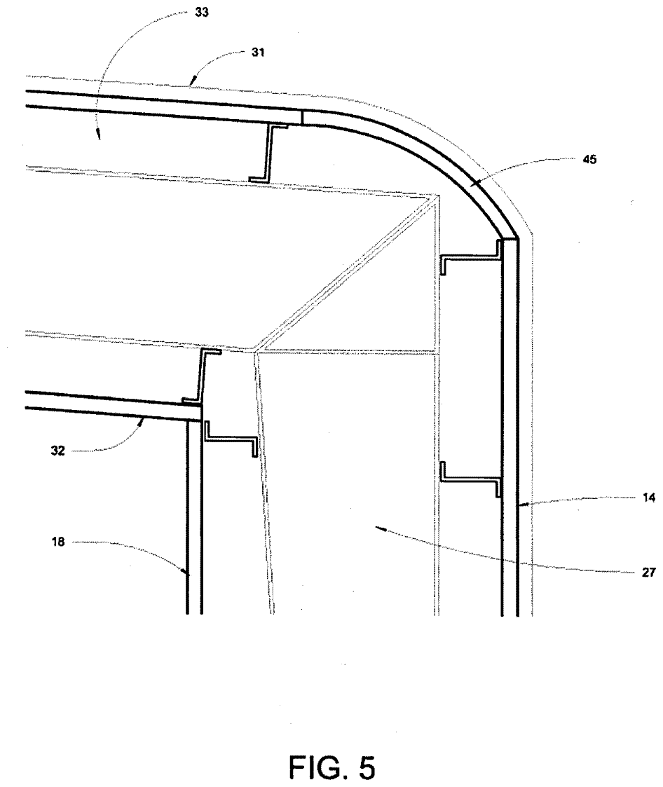

With reference to FIGS. 4 and 5, cavities 27 and 33 are connected for fluid flow by means of a an open cavity with an optional radius eave coupling 45 which facilitates fluid flow from cavity 27 to cavity 33 and vice versa. Coupling 45 may be made of the same material as are the walls and roof/ceiling. However, the function of air/gas coupling of the wall and roof chambers is to permit fluid flow so it is not required that it be light transmissive. Roof panels 31 may transition to external wall panels 14 if desired.

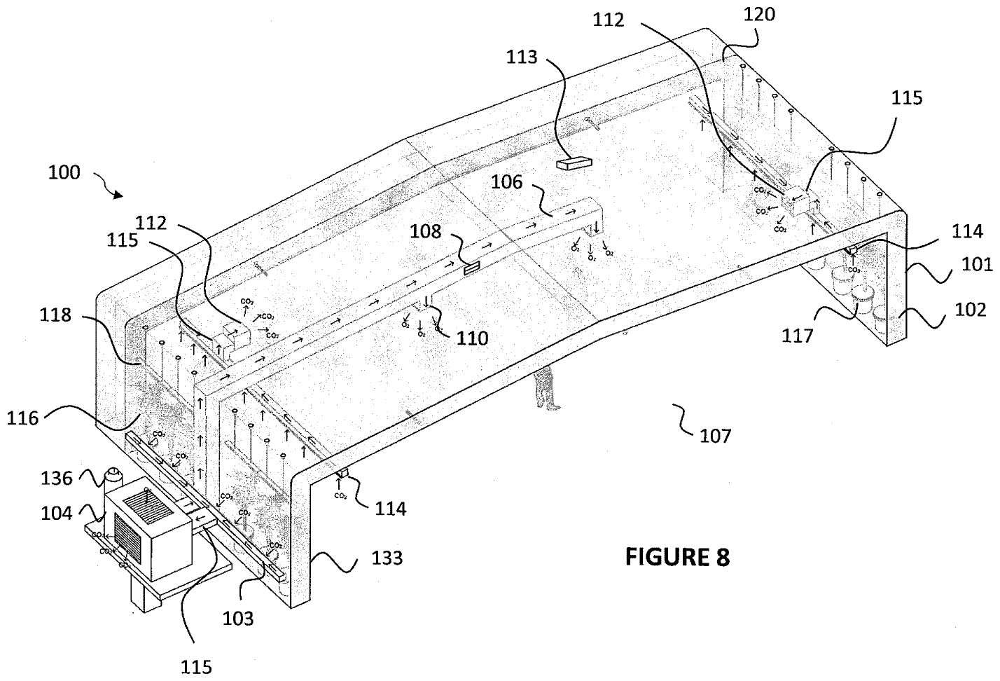

Referring now to FIG. 8 an alternative embodiment of the present invention is shown with a cavity buffer and treatment system 100 installed. Building structure 101 is shown along with cavity 102 and HVAC unit 104. HVAC unit 104 is shown on the side of building structure 101, but it can be installed on the roof. Further only a singular HVAC unit 104 is shown, but it is fully envisioned that more than one HVAC unit 104 can be used. Building structure 101 can be any building type, but is shown here as a retrofitted industrial style building to provide an illustrative overview of how cavity buffer and treatment system 100 works. Cavity 102 functions as an additional insulative layer to improve the efficiency of HVAC unit 104. The air within cavity 102 is constantly circulated so that air within cavity 102 cannot increase in temperature by remaining stagnate within the cavity. So, with cavity buffer and treatment system 100 installed, the temperature difference between cavity 102 and occupied space 107 is significantly lower, resulting in less heat transfer between the two spaces.

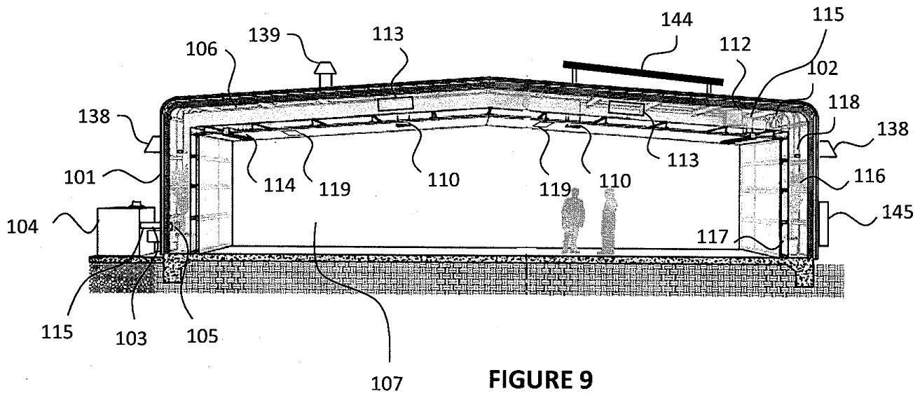

Cavity exhaust fan 113 circulates the air within cavity 102 to improve the heat transfer coefficient of the roof structure and the ceiling panels that are exposed within cavity 102. The air that is circulated is not able to increase in temperature, instead, the air is exhausted out of building structure 101 through either roof vent 139, wall vent 138, or some combination of both (both roof vent 139 and wall vent 138 are shown in FIG. 9). The negative pressure created in cavity 102 by the exhausting air will cause some of the cooler air being delivered to occupied space 107 to flow into cavity 102. The travel of cooler air into cavity 102 and the exhausting of hot air out of cavity 102 is enough to significantly reduce the temperature of the air within cavity 102. As a consequence, this lower temperature differential greatly improves the efficiency of HVAC unit 104 as it treats the air of occupied space 107. Cavity exhaust fan 113 in some embodiments is an inline exhaust fan, however, any other type of exhaust fan is fully envisioned, such as ceiling exhaust fans. Finally, while only one cavity exhaust fan 113 is shown, it is fully envisioned that more than one cavity exhaust fan 113 can be used.

Alternatively, HVAC unit 104 and cavity exhaust fan 113 work in sync with each other. Supply duct 106 runs through cavity 102 to deliver air to occupied space 107 through supply vent 110. Cavity supply ducts 108 deliver some of the air in supply duct 106 to cavity 102. The amount of air delivered by cavity supply ducts 108 is roughly the same amount of air that is being exhaust by interior exhaust fan 113 to maintain a neutral air pressure within cavity 102. Cavity buffer and treatment system 100 may also have exhaust fans 112 that exhaust air from occupied space 107.

Cavity supply vent 108, interior supply vent 110, exhaust vent 114, and return vent 105 (shown in FIG. 9) can be manually set to a predetermined position to achieve proper airflow. In some embodiments, these vents are set up to operate automatically depending on the temperature of a given space. So, in some embodiments the different vents can automatically open up or close up to adjust the airflow based on the temperature of either cavity 102 or occupied space 107.

When the HVAC unit 104 and cavity exhaust fan 113 work in sync with each other, there are some embodiments envisioned where the cavity buffer and treatment system 100 doubles as a sound insulation system. As the air travels through cavity 102, any sound that penetrates building structure 101 will be redirected by the air flow of HVAC unit 104 and cavity exhaust fan 113. The redirection of outside soundwaves prevents them from traveling across cavity 102 and penetrating interior wall 133. In these embodiments, occupied space 107 has much better sound insulation ratings and the quality of sound produced within occupied space 107 is much improved as a consequence.

HVAC unit 104 is primarily sized to treat occupied space 107, but the inclusion of cavity 102 in the sizing of HVAC unit 104 has a minimal impact. In a non-limiting example, occupied space 107 may require only a 3-ton HVAC unit, but the additional cooling needs of cavity 102, may still fall within the capacity of the 3-ton unit, or it may need to be only upsized to the 3.5 ton unit. HVAC unit 104 is shown in FIGS. 8 and 9 as a typical outdoor air conditioning unit that is common place in the art, but it is fully envisioned that any type of HVAC unit currently known in the art can be used. For instance, it is fully envisioned that HVAC unit 104 can be a heat pump, or the condensing unit for a split system. It is also fully envisioned that HVAC unit 104 can be a unit that is able to dehumidify the air located within occupied space 107 and cavity 102 in addition to lowering the air temperature.

Further, HVAC unit 104 may not treat the entire space of cavity 102. In some embodiments cavity 102 is broken up into individual zones through the use of dividing panel 120. Dividing panel 120 separates the different areas of cavity 102 depending on the planned use for occupied space 107. Dividing panel 120 is shown here laterally dividing cavity 102 into two different sections, but that is not intended to be limiting. It is fully envisioned that in some embodiments dividing panel 120 divides cavity 102 transversely as well.

Exhaust fans 112 are placed over occupied space 107 to primarily pull air from occupied space 107 in order to extract carbon dioxide (CO₂) from the air through exhaust vents 114. This lowers the overall carbon footprint of building structure 101. The CO₂ can be captured either through direct air capture methods, or alternatively through the use of plants 116 that have a high absorption rate for CO₂. In some embodiments, exhaust fans 112 are installed with filters 115 to capture the carbon dioxide that is located within occupied space 107.

Filters 115 are made out of electrically charged membranes that have a dry side and a wet side. The dry side of filter 115 is coated with a solvent that has a high affinity for carbon dioxide. The wet side of filter 115 has a positively charged electrode located on it. The carbon dioxide that is in the air that flows through filter 115 binds to the solvent on the dry side to form bicarbonate. The bicarbonate that forms is slowly pulled over to the wet side and is stored within the wet side. Once filter 115 is at capacity, an individual simply needs to replace filter 115. In some embodiments, HVAC unit 104 has its own filter 115 to improve the carbon capture rate of the entire cavity buffer and treatment system 100.

Plants 116 can be selected from a wide variety of different plants including, but not limited to, Prayer Plants, Boston Ferns, Weeping Figs, Olivera Spider Plants, Gerbera Daisies, Peace Lillies, Golden Pathos, Money Plants, and Snake Plants. Plants 116 are planted into pots 117 and has its own dedicated irrigation system to ensure that the plants remain healthy. UV lighting 118 is mounted some distance above plants 116 and/or on the side of plants 116 to provide artificial lighting. UV lighting 118 can be either UV-A style lighting or UV-B style lighting, but the final selection is dependent on the plants and environment of cavity 102. However, UV lighting 118 may not be required if building structure 101 is transparent.

The constant airflow of cavity buffer and treatment system 100 prevents any condensation forming within cavity 102 that may result from the growing of plants 116. By eliminating the risk of condensation from within cavity 102, then it lowers the risk of any mold or mildew from forming within cavity 102.

In some embodiments, different chemicals can be pumped into cavity 102 in lieu of using plants 116 to improve carbon capture. These chemicals are pumped into cavity 102 by cannister 136 and the preferred chemicals are chlorophyll biosynthesis promoters such as iron chelates (Fe-EDTA), magnesium sulfate (MgSO₄), nitrogen fertilizers (such as ammonium nitrate), and ALA-based plant growth stimulants. These chemicals stimulate the growth of chlorophyll within cavity 102 so that the carbon dioxide can be absorbed. In other embodiments, ground-up enhanced rock weathering can be used as another method for carbon capture in the cavity.

Referring now to FIG. 9, a section view of building structure 101 is shown. In this section view, wall vents 138 and roof vent 139 can be seen. These are the two different vents that cavity exhaust fan 113 can connect to and subsequently exhaust air through. Additionally shown in this view are two different cavity exhaust fans 113. It is fully envisioned that there can be any number of cavity exhaust fans 113 that are installed within cavity 102. Multiple cavity exhaust fans 113 may be necessary to ensure proper airflow from one side of cavity 102 to the other side. Ceiling panel 119 provides access to the mechanical equipment located within cavity 102 and can be located in a variety of different areas.

Multiple cavity exhaust fans 113 may also be necessary when return duct 103 of HVAC unit 104 has return grill 105 in only one location. FIG. 9 shows return grill 105 in cavity 102 adjacent to plants 116. Due to the design of cavity 102, air flow may be impeded and only a small amount of air within cavity 102 actually returns to HVAC unit 104. The use of cavity exhaust fans 113 correct this issue by pulling the air from all locations within cavity 102 and directing it towards return grill 105.

Both supply duct 106 and return duct 103 are constructed out of sheet metal to ensure proper airflow and longevity of each duct. But, in other embodiments, supply duct 106 and return duct 103 may be constructed out of a variety of different materials that are currently known in the art. This includes, but is not limited to, fiberboard air ducts, fiberglass, flexible plastic air ducts, and poly carbonate glass. The flexibility in material selection for supply duct 106 and return duct 103 allows cavity buffer and treatment system 100 to be installed in a wide variety of different environments.

Solar panel 144 provides supplemental energy for some embodiments of cavity buffer and treatment system 100. Solar panel 144 is particularly beneficial when cavity buffer and treatment system 100 is installed on a building that has high rates of sunlight exposure. Solar panel 144 is used to either offset the electrical demands for cavity buffer and treatment system 100, or alternatively, it can be used to fully power all of the different components. This greatly reduces the carbon footprint of cavity buffer and treatment system 100. Further, any excess energy that is generated by solar panel 144 can be stored in battery storage system 145. Battery storage system 145 can be located on the interior or the exterior of building structure 101 and consists of one or more batteries for energy storage.

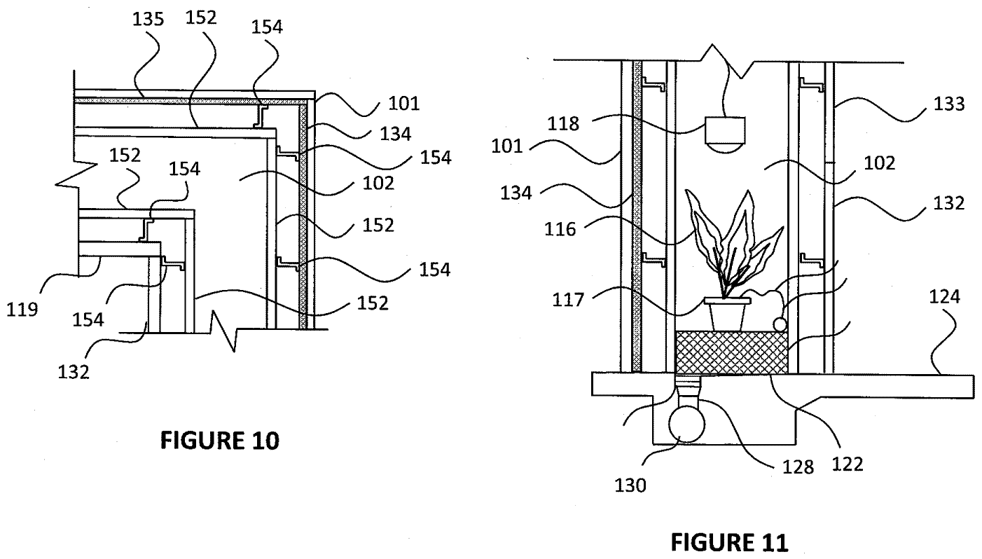

Referring now to FIG. 10, a close-up section view of building structure 101 with cavity buffer and treatment system 100 installed is shown. This view details the different materials that may be used to form cavity 102. Building structure 101 has wall insulation 134 and roof insulation 135 mounted onto its interior facing surface. Building joists 154 can either be existing joists or part of new construction. Wall insulation 134 and roof insulation 135 are shown mounted directly onto building joists 154, but this is not intended to be limiting. Instead, both wall insulation 134 and roof insulation 135 can be mounted in between building joists 154, or mounted in any manner that is currently known in the art. Building joists 154 can be constructed out of a wide variety of materials for new construction; including but not limited to, wood, steel, iron, or any other material known in the art that would be a suitable substitute.

Interior cavity panels 152 are mounted directly onto the side of building joists 154 that face cavity 102 and the two panels may be positioned at any given distance apart. Interior cavity panels 152 are envisioned to be used in some embodiments where more efficient airflow is required. Covering building joists 154 with interior cavity panels 152 ensures that there is no turbulent airflow. When interior cavity panels 152 are not needed then cavity buffer and treatment system 100 can treat the open space between building structure 101, building joists 154, and wall panel 132. Interior cavity panels 152 can be constructed out of non-corrosive, non-absorbent, and/or mildew resistant materials. Additionally, interior cavity panels 152 can be rigid, flexible, translucent, or even opaque depending on the needs of building structure 101. Finally, in some embodiments, interior cavity panels 152 can be completely sealed to ensure that no air within cavity 102 leaks out, or alternatively the interior cavity panels 152 can only be partially sealed or not sealed at all.

Referring now to FIG. 11, a close-up section view of cavity buffer and treatment system 100 with plants 116 installed is shown. In this view, the different components that are required to ensure the health of plants 116 is detailed. Each plant 116 that is installed within cavity 102 has its own individual pot 117. In alternative embodiments it is fully envisioned that in place of pot 117, plants 116 can all be planted in a planter box that runs the entire length of cavity 102, or be planted in accordance with any other method currently known in the art. Further, in alternative embodiments, plant 117 can be planted directly on top of soil 125 as shown. Soil 125 is weatherized rock soil that improves the absorption rates of carbon dioxide within cavity 102. Irrigation pipe 120 can run the length of cavity 102 and be located inside cavity 102 where it is convenient to do so. Drip system 121 runs from irrigation pipe 120 to the interior of pot 117 so that water can reach plant 116 without interruption. Each drip system 121 has an emitter (not shown) to slowly irrigate each plant 117 over time. A benefit of using an emitter is that plants 116 only receive the proper amount of water and the risk of under or over watering is properly mitigated.

Any water that leaks through pot 117 or irrigation pipe 120 is able to run along slopped floor 122 towards drain cover 126 so that it is collected by drain pipe 128 that is directly connected to building drainage or sewer pipe 130. Slopped floor 122 is an extension of interior floor 124 and has a subtle slope downward towards drain cover 126. The subtle slope of slopped floor 122 ensures that any extra water will flow down towards drain cover 126 and will be unable to pool within cavity 102. If pooling were allowed to take place, then the risk of mildew and mold growth would increase significantly.

UV lighting 118 is shown directly above plant 116. In some embodiments, cavity 102 has wall insulation that runs along the exterior walls of building structure 101. This prevents plants 116 from being exposed to any natural sunlight and UV lighting 118 is used to supplement the missing sunlight.

Also shown in FIG. 11 is wall panel 132. Wall panel 132 are removable panels installed along interior wall 133 that provide access to cavity 102. In the event that maintenance needs to be performed within cavity 102, such as repair of drip system 121, all an individual needs to do is remove the relevant wall panel 132. There are multiple different wall panels 132 that run the length of cavity 102, so almost any point can be easily accessed. Wall panel 132 can also have a number of different appearances. In a non-limiting example, wall panel 132 can be constructed out of transparent materials, allowing plants 116 to double as a decorative feature in addition to being placed to absorb carbon dioxide. In another non-limiting example, wall panel 132 can have decorative features on the front facing side to easily add an art display for the occupants of occupied space 107 to see. In another non-limiting example, wall panel 132 can be constructed out of LED smart panels that display any image that an individual wants displayed onto wall panel 132.

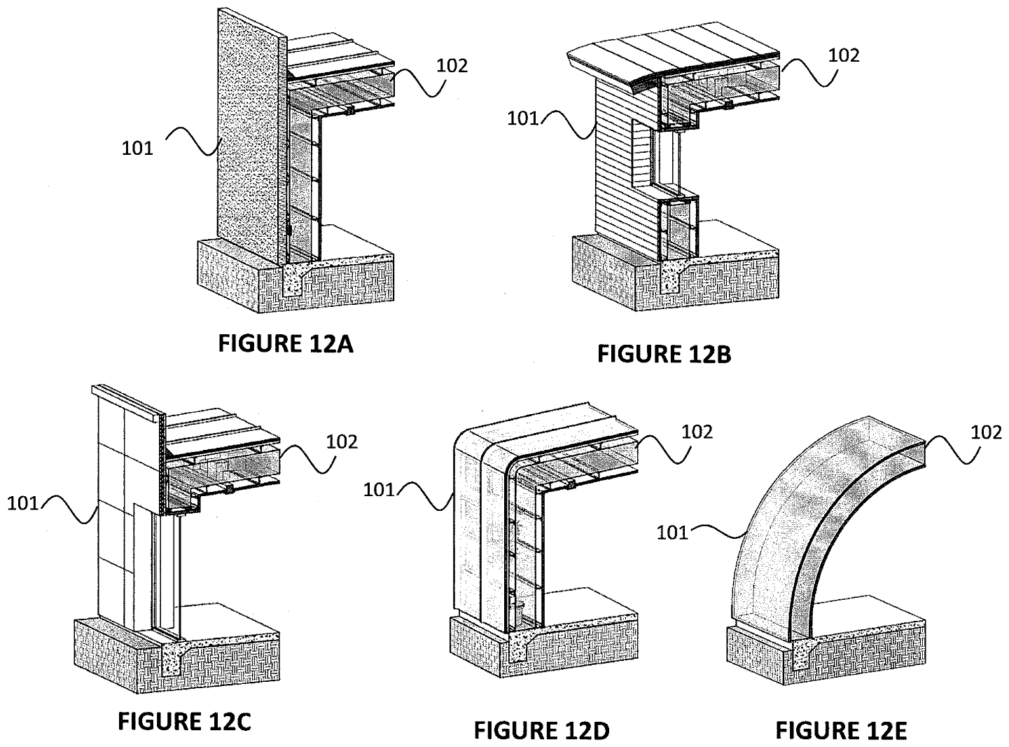

Referring now to FIGS. 12A through 12E, vignette views of different building types are shown with cavity buffer and treatment system 100 installed. Cavity and buffer system 100 can be easily installed during new construction or through a retro fit process. Critically, the use case of the building has a minimal impact on the overall design of cavity buffer and treatment system 100. Instead, the system is custom tailored to meet the needs of the individual project. FIG. 12A shows cavity buffer and treatment system 100 installed in an industrial building, FIG. 12B shows the system installed in a residential building, FIG. 12C shows the system installed in a commercial building, and finally, FIG. 12D shows the system installed in a greenhouse, and FIG. 12E shows the system installed in a hoop house.

One of the main requirements for installation of cavity buffer and treatment system 100 is that there be a building structure 101 and enough space within building structure 101 to have enough space for cavity 102. These different building structures shows the versatility of cavity buffer and treatment system 100 because the system is capable of providing continuous airflow to structures that do not have any breaks in cavity 102 (such as what occurs due to door placement or window placement shown in FIGS. 12B and 12C), but it can also treat air within cavity 102 when these interruptions are present.

Building structure 101 can be constructed out of a variety of different materials. This includes but is not limited to building materials such as steel, aluminum, tetrahedron, or any other material currently known in the art. Additionally, building structure 101 can be constructed to form a truss structure, honeycomb structure, or any other structure that is known in the art.

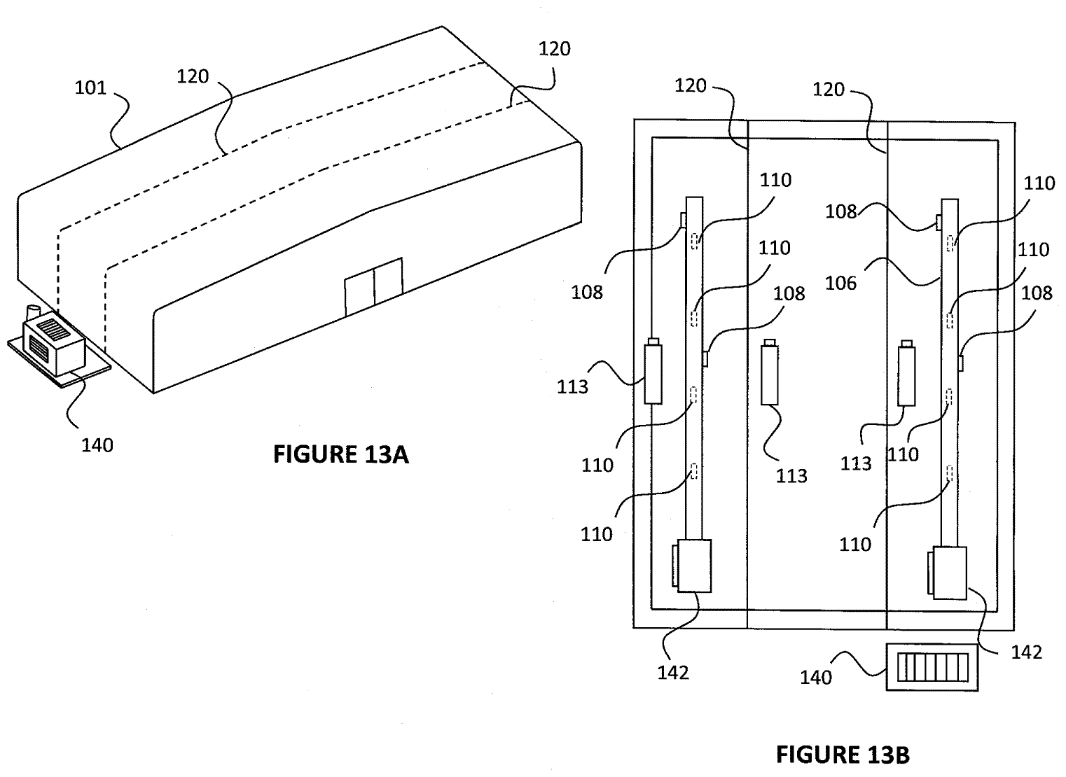

Referring now to FIGS. 13A and 13B an alternative embodiment of cavity and buffer system 100 is shown. In this alternative embodiment, a split system is used for multi zone control because there are multiple different cavities 102 present within building structure 101. Multi zone control may be needed in instances where there are multiple different dividing panels 120 as shown here. Each zone may have its own specific heating and cooling requirements that is dependent on the planned uses for occupied space 107. Heat pump 140 is used in lieu of HVAC unit 104, and heat pump 140 is connected to two different air handling units 142, but this is not intended to be limiting. In fact, heat pump 140 can be of any size to accommodate any number of air handling units for larger buildings, additionally, if the building is too large for one heat pump 140 to handle, then the use of additional heat pumps 140 along the exterior of building 101 is fully envisioned.

Specific to FIG. 13B, there are three different zones shown. Air handler unit 142 is able to treat the air within cavity 102 (not shown in these Figures) and within occupied space 107 (shown in FIG. 8) when installed within a specific zone. All three zones have their own cavity exhaust fans 113 and only two have air handler 142. This may be ideal when a specific area of occupied space 107 has different temperature requirements, so it may not be necessary to have additional cooling within a specific area of cavity 102. In scenarios where more than one cavity 102 is required, then any number of panels can be used to achieve the desired effect. FIG. 12B shows two different dividing panels 120, but this is not intended to be limiting as any number of individual zones, each with their own dividing panels 120 and interior cavity panels 152 can be used.

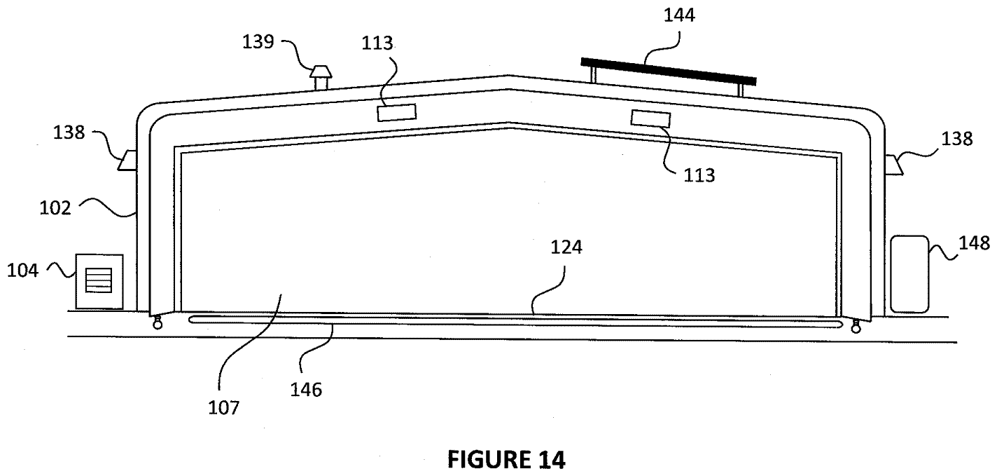

Referring now to FIG. 14, a side section view of an alternative embodiment of cavity buffer and treatment system 100 is shown. In this alternative embodiment, radiant piping 146 and radiant water heater 148 are used to have a radiant heating system installed within interior floor 124. Having a radiant heating system installed below occupied space 107 improves the efficiency of cavity buffer and treatment system 100 because radiant piping 146 functions as an insulation layer for interior floor 124. The radiant heat from radiant piping 146 prevents the outside temperature of the soil transferring into occupied space 107 and helps maintain the temperature within occupied space 107. Radiant water heater 148 is located on the outside of building structure 102, but that is not intended to be limiting. It is fully envisioned that radiant water heater 148 can be installed at any location that is the most convenient, including any location that is within the building's interior or mounted onto the roof of the building if needed.

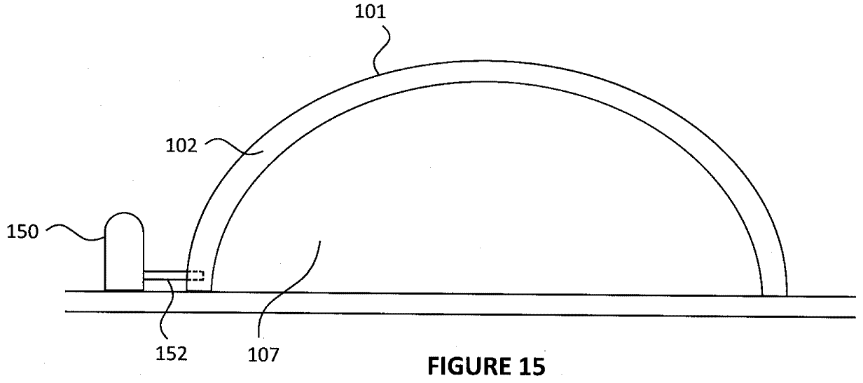

Referring now to FIG. 15, an alternative embodiment of the cavity buffer and treatment system where gas canister 150 is used in lieu of HVAC unit 104 is shown. In this alternative embodiment, building structure 101 is a hoop house, alternatively known as an outdoor greenhouse. Gas canister 150 pumps different chemical mixtures into cavity 102 through gas piping 152 and the final gas composition is dependent on the use case of building structure 101. In a non-limiting example, a user can pump in a gas to obscure the contents of occupied space 107 to the outside. In another non-limiting example, gas canister can pump in gas that reflects sunlight, such as sulfur dioxide, to improve the insulative value of building structure 101.

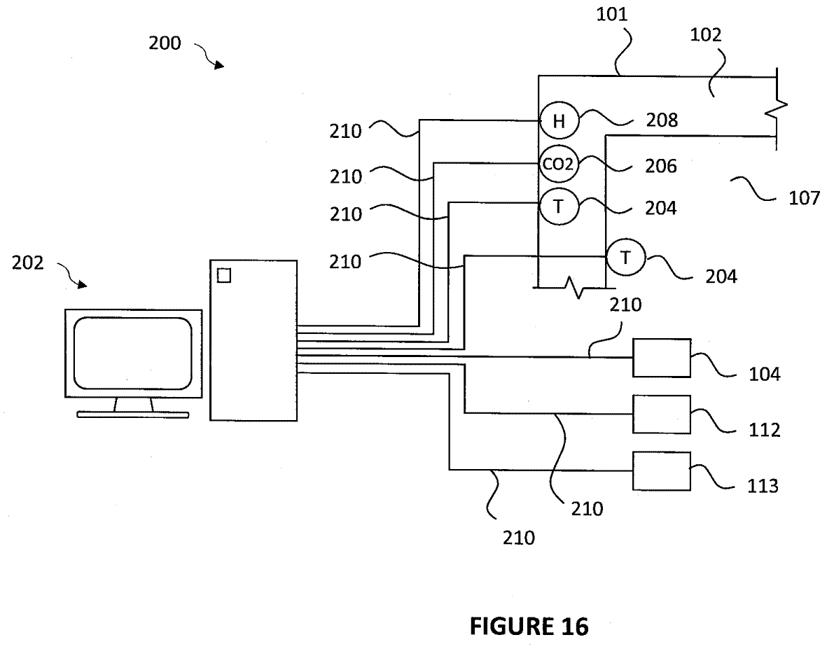

Referring now to FIG. 16, a schematic of a control system for cavity buffer and treatment system 100 is shown generally designated as system 200. In this embodiment, system 200 is operated by computer system 202, but this is not intended to be limiting as system 200 can be run by any device that has an operating system such as a smart tablet, smart phone, or any other device currently known in the art. Cavity 102 will have one or more temperature sensors 204, one or more carbon dioxide sensors 206, and one or more humidity sensors 208. These three sensor types ensure that the air within cavity 102 is properly treated to meet the use case of building structure 101. A subsequent system of temperature sensors 204 may also be located within occupied space 107 in those embodiments where HVAC unit 104 is treating the air within occupied space 107 in addition to the air located within cavity 102. Temperature sensors 204 can be a separate component from the different wall panels used, or in some embodiments, they can be fully integrated into wall panels when smart panels are used. This configuration would allow the different wall panels to communicate directly with each other through control system 200. The operation of the individual components that make up cavity buffer and treatment system 100 is simultaneous based on the information that is sent to computer station 202 from the sensors. It is fully envisioned that one or more HVAC units 104, exhaust fans 112, cavity exhaust fans 113, and drip systems 121 may be operated at the same time. All of the different sensors and components are shown here having wired bidirectional communication links 210. However, that is not intended to be limiting as it is fully envisioned that system 200 can operate wirelessly through a Wi-Fi connection, Bluetooth connection, or any other wireless method that is currently known in the art.

While the concept focuses on a novel greenhouse structure, the resulting building could be used for any function, use, or purpose. It provides a controlled environment that is particularly useful as a greenhouse, which does not prevent the building from being used for other purposes.

I claim:

1. A cavity buffer and treatment system comprising:
a building structure having an exterior;
an interior structure located some distance away from the building structure;
a cavity that is formed by the space in-between the building structure and the interior structure;
at least one HVAC unit that is place outside of the building structure;
at least one first exhaust fan that is located within the cavity, and
wherein air that is located within the cavity is treated by the at least one HVAC unit and the at least one exhaust fan.

2. The cavity buffer and treatment system of claim 1 further comprising a supply duct and a return duct that is connected to the at least one HVAC unit.

3. The cavity buffer and treatment system of claim 2 wherein the supply duct has at least one supply vent that delivers air to the cavity.

4. The cavity buffer and treatment system of claim 3 wherein the return duct has at least one return grill open to the cavity.

5. The cavity buffer and treatment system of claim 4, further comprising at least one second exhaust fan installed on the interior structure to pull air from an occupied space of the building structure.

6. The cavity buffer and treatment system of claim 5, further comprising at least one pot and at least one plant, wherein the at least one plant has a high affinity for carbon dioxide.

7. The cavity buffer and treatment system of claim 6, further comprising an irrigation system to water the at least one plant.

8. The cavity buffer and treatment system of claim 7, further comprising at least one dividing wall that separates the cavity into different zones.

9. The cavity buffer and treatment system of claim 8, wherein the at least one first exhaust fan is an inline exhaust fan and the at least one second exhaust fan is a ceiling exhaust fan.

10. A cavity buffer and treatment system comprising:
a building structure having an exterior and an occupied space;
an interior structure that is located some distance between the building structure and the occupied space, thereby forming a cavity;
at least one HVAC unit that is configured to treat air located within the cavity and the occupied space;
at least one first exhaust fan that is located within the cavity to circulate the air located within the cavity; and
at least one second exhaust fan that is located on the interior structure to pull air from the occupied space of the building structure.

11. The cavity buffer and treatment system of claim 10 further comprising a supply duct and a return duct that is connected to the at least one HVAC unit.

12. The cavity buffer and treatment system of claim 11 wherein the supply duct has at least one supply vent that delivers air to the cavity and at least one supply vent that delivers air to the occupied space.

13. The cavity buffer and treatment system of claim 12 wherein the return duct has at least one return grill open to the cavity.

14. The cavity buffer and treatment system of claim 13, further comprising at least one pot and at least one plant, wherein the at least one plant has a high affinity for carbon dioxide.

15. The cavity buffer and treatment system of claim 14, further comprising an irrigation system to water the at least one plant.

16. The cavity buffer and treatment system of claim 15, further comprising at least one dividing wall that separates the cavity into different zones.

17. The cavity buffer and treatment system of claim 16, wherein the at least one first exhaust fan is an inline exhaust fan and the at least one second exhaust fan is a ceiling exhaust fan.
